(19) United States
(12) Patent Application Publication
(10) Pub. No.: US 2022/0309525 A1
(43) Pub. Date: Sep. 29, 2022

(54) MACHINE LEARNING MODEL FOR PREDICTING CLIENT SENSITIVITY TO RATE CHANGES IN COMMERCIAL DEPOSIT PRODUCTS

(71) Applicant: MCKINSEY & COMPANY, INC., New York, NY (US)

(72) Inventors: Sonia Thekknedath, Atlanta, GA (US); Pallavi Shah, Atlanta, GA (US); Kuba Zielinski, Somerville, MA (US); Matthew A. Fitzpatrick, Amagansett, NY (US); Junru He, Weston, MA (US); Vik Sohoni, Chicago, IL (US); Kweilin Ellingrud, Minnetonka, MN (US); Piotr Kaminski, Princeton, NJ (US)

(21) Appl. No.: 17/697,128

(22) Filed: Mar. 17, 2022

Related U.S. Application Data
(60) Provisional application No. 63/167,273, filed on Mar. 29, 2021.

(51) Int. Cl. G06Q 30/02; G06Q 40/02

(52) U.S. Cl. CPC G06Q 30/0202; G06Q 30/0201; G06Q 40/02; G06N 20/20

(57) ABSTRACT

To predict client sensitivity to rate changes for commercial deposit products, a machine learning model is trained using (i) first attributes associated with a corresponding first client during a first rate change, (ii) an indication of whether the first rate change was requested by the corresponding first client or by a corresponding first bank, and (iii) an indication of whether the corresponding first client is sensitive to the first rate change. A second set of attributes is obtained which is associated with a second client having a second commercial deposit product. A machine learning engine applies the second set of attributes and an indication of an initiator of a potential second rate change to the machine learning model to predict client sensitivity to the potential second rate change. Then, a recommendation is provided as to whether to change the second rate based on the predicted client sensitivity.

### CROSS-REFERENCE TO RELATED APPLICATIONS

This application claims priority to and the benefit of the filing date of provisional U.S. Patent Application No. 63/167,273 entitled “Machine Learning Model for Predicting Client Sensitivity to Rate Changes in Commercial Deposit Products,” filed on Mar. 29, 2021, the entire contents of which is hereby expressly incorporated herein by reference.

### FIELD OF THE DISCLOSURE

The present disclosure relates to machine learning and, more particularly, to predicting client sensitivity to rate changes in commercial deposit products using machine learning techniques.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many banks offer commercial deposit products to help client organizations manage their money. These commercial deposit products include business checking accounts, business savings accounts, business money market accounts, etc. While some commercial deposit products provide interest on the money deposited at the bank, others provide an earnings credit rate (ECR). An ECR is similar to interest but instead of providing cash in the client's account in accordance with the amount of interest earned, an ECR is used to offset service charges by the bank.

Periodically, banks may adjust the rates of interest or ECR for commercial deposit products. The banks may adjust the rates on their own (proactively), or in response to requests from clients for adjusted rates (reactively). In some scenarios, rate adjustments may cause clients to substantially alter their balances. For example, in the event of an upward rate adjustment, a client may significantly increase the amount of money deposited at the bank. In the event of a downward rate adjustment, a client may significantly decrease their balance at the bank. However, it is difficult for the bank to predict how a client will react to a rate adjustment.

### SUMMARY

To predict how a client is likely to react to a rate adjustment for a commercial deposit product, a machine learning engine in a server device may train a machine learning model using attributes associated with clients that previously experienced a rate adjustment. Client sensitivity metrics may be assigned to each of these clients based on changes to their balances in the following months after the rate adjustment. For example, clients who increase their balance by more than a threshold amount over a threshold time period in response to an upward rate adjustment may be assigned a client sensitivity metric of 1. Clients who do not increase their balance by more than the threshold amount over the threshold time period in response to an upward rate adjustment may be assigned a client sensitivity metric of 0. Clients who decrease their balance by more than a threshold amount over a threshold time period in response to a downward rate adjustment may be assigned a client sensitivity metric of 1. Clients who do not decrease their balance by more than the threshold amount over the threshold time period in response to a downward rate adjustment may be assigned a client sensitivity metric of 0. In other implementations, the machine learning engine may assign client sensitivity metrics between 0 and 1 or the client sensitivity metric may be any suitable number.

In any event, for each rate adjustment, the machine learning engine may determine whether the rate adjustment was initiated by the bank (also referred to herein as a “proactive” rate adjustment) or by the client (also referred to herein as a “reactive” rate adjustment). The machine learning engine may segment the rate adjustments and corresponding attributes and client sensitivity metrics into a proactive rate adjustment segment and a reactive rate adjustment segment. Then the machine learning engine may generate a machine learning model based on the attributes, client sensitivity metric, and segment for each rate adjustment for commercial deposit products. In some implementations, the machine learning engine may generate separate machine learning models for the proactive and reactive segments, such that the machine learning engine generates a first machine learning model based on the attributes and client sensitivity metrics for the proactive rate adjustments and a second machine learning model based on the attributes and client sensitivity metrics for the reactive rate adjustments. Additionally, in some implementations, the machine learning engine may generate separate machine learning models for rate increases and rate decreases.

More specifically, the attributes for each segment may be classified according to their respective client sensitivity metrics (e.g., for the proactive segment, a first set of attributes having a first client sensitivity metric may be classified into a first group, a second set of attributes having a second client sensitivity metric may be classified into a second group, etc.), and the machine learning engine may analyze the attributes in each group for the segment to generate the machine learning model.

The attributes of a rate adjustment for a client may include client-product attributes (e.g., a base rate, the change in the rate from the base rate to a new rate, an initial balance for the commercial deposit product, a change in balance after the change in the rate, etc.), client level attributes (e.g., a total balance between the client and the corresponding bank, a relationship metric between the client and the corresponding bank, etc.), client level meta data (e.g., a location of the client, a sales metric for the client, etc.), industry attributes, (e.g., a difference between an industry rate and the base rate, a difference between a federal funds rate and the base rate, a difference between a treasury bill rate and the base rate, etc.), or any other suitable attributes.

When a bank is deciding whether to adjust a rate for a client's commercial deposit product, either on its own or based on a request from the client, the machine learning engine may obtain attributes associated with the potential rate adjustment for the client, and an indication of whether the potential rate adjustment is proactive or reactive. The machine learning engine may then apply the attributes and the proactive/reactive indicator to the machine learning model to determine a client sensitivity metric for the client. For example, when the machine learning model generates a client sensitivity metric of 1, this may indicate that the client is likely to significantly increase or decrease their balance in response to the rate adjustment. When the machine learning model generates a client sensitivity metric of 0, this may indicate that the client is unlikely to significantly increase or decrease their balance in response to the rate adjustment.

The machine learning engine may then generate and provide a recommendation to the bank of whether to adjust the rate for the commercial deposit product based on the client sensitivity metric. For example, when the rate adjustment is an upward rate adjustment and the client sensitivity metric is 1 or another suitable metric indicating that the client is sensitive to rate adjustments, the machine learning engine may recommend proceeding with the rate adjustment which may cause the client to significantly increase their balance. When the rate adjustment is a downward rate adjustment and the client sensitivity metric is 1 or another suitable metric indicating that the client is sensitive to rate adjustments, the machine learning engine may not recommend proceeding with the rate adjustment to prevent the client from significantly decreasing their balance. When the rate adjustment is an upward rate adjustment and the client sensitivity metric is 0 or another suitable metric indicating that the client is not sensitive to rate adjustments, the machine learning engine may not recommend proceeding with the rate adjustment to avoid paying higher rates when it is not likely to lead to additional deposits from the client. When the rate adjustment is a downward rate adjustment and the client sensitivity metric is 0 or another suitable metric indicating that the client is not sensitive to rate adjustments, the machine learning engine may recommend proceeding with the rate adjustment to pay lower rates when it is unlikely that the client will withdraw from their balance.

In this manner, the machine learning engine may accurately predict how a client will respond to rate adjustments and the bank may determine how to proceed accordingly, such that the bank may change rates without losing clients. Furthermore, by segmenting the training data into proactive and reactive rate adjustment segments, the machine learning engine generates more accurate models for predicting client sensitivity compared to alternative systems that do not segment the training data. The segmentation of the training data into proactive and reactive rate adjustment segments results in significant increases in coefficients used to measure the accuracy of the model, such as the area under the receiver operating characteristic (ROC) curve (AUC), the Gini coefficient, and the Kolmogorov-Smirnov (K-S) statistic.

In particular, an example embodiment of the techniques of the present disclosure is a method for predicting client sensitivity to changes in rates. The method includes training a machine learning model using for each of a plurality of first commercial deposit products provided by one or more first banks for one or more first clients experiencing a change in a first rate, (i) first attributes associated with a corresponding first client during the change in the first rate for the first commercial deposit product, (ii) an indication of whether the change in the first rate was requested by the corresponding first client or by a corresponding first bank, and (iii) an indication of whether the corresponding first client is sensitive to the change in the first rate. The method further includes obtaining a second set of attributes associated with a second client having a second commercial deposit product provided by a second bank, determining, whether a potential change in a second rate for the second commercial deposit product for the second client is initiated by the second client or the second bank, and applying the second set of attributes associated with the second client and an indication of an initiator of the potential second rate change to the machine learning model to predict client sensitivity to the potential second rate change. Furthermore, the method includes providing a recommendation of whether to change the second rate based on the predicted client sensitivity.

Another embodiment of these techniques is a computing device for predicting client sensitivity to changes in rates. The computing device includes one or more processors and a non-transitory computer-readable medium storing instructions thereon. When executed by the one or more processors, the instructions cause the computing device to train a machine learning model using for each of a plurality of first commercial deposit products provided by one or more first banks for one or more first clients experiencing a change in a first rate, (i) first attributes associated with a corresponding first client during the change in the first rate for the first commercial deposit product, (ii) an indication of whether the change in the first rate was requested by the corresponding first client or by a corresponding first bank, and (iii) an indication of whether the corresponding first client is sensitive to the change in the first rate. The instructions further cause the computing device to obtain a second set of attributes associated with a second client having a second commercial deposit product provided by a second bank, determine whether a potential change in a second rate for the second commercial deposit product for the second client is initiated by the second client or the second bank, and apply the second set of attributes associated with the second client and an indication of an initiator of the potential second rate change to the machine learning model to predict client sensitivity to the potential second rate change. Additionally, the instructions cause the computing device to provide a recommendation of whether to change the second rate based on the predicted client sensitivity.

Yet another embodiment of these techniques is a non-transitory computer-readable memory coupled to the one or more processors and storing instructions thereon. When executed by the one or more processors, the instructions cause the one or more processors to train a machine learning model using for each of a plurality of first commercial deposit products provided by one or more first banks for one or more first clients experiencing a change in a first rate, (i) first attributes associated with a corresponding first client during the change in the first rate for the first commercial deposit product, (ii) an indication of whether the change in the first rate was requested by the corresponding first client or by a corresponding first bank, and (iii) an indication of whether the corresponding first client is sensitive to the change in the first rate. The instructions further cause the one or more processors to obtain a second set of attributes associated with a second client having a second commercial deposit product provided by a second bank, determine whether a potential change in a second rate for the second commercial deposit product for the second client is initiated by the second client or the second bank, and apply the second set of attributes associated with the second client and an indication of an initiator of the potential second rate change to the machine learning model to predict client sensitivity to the potential second rate change. Additionally, the instructions cause the one or more processors to provide a recommendation of whether to change the second rate based on the predicted client sensitivity.

### BRIEF DESCRIPTION OF THE DRAWINGS

FIG. 1 illustrates a block diagram of an example communication system in which techniques for predicting client sensitivity to changes in rates can be implemented;

FIG. 2A illustrates a block diagram of an example client sensitivity assessment server that can operate in the system of FIG. 1;

FIG. 2B is a block diagram of an example client device that can operate in the system of FIG. 1;

FIG. 3 illustrates an example data table including attributes of rate adjustments which the system of FIG. 1 can utilize to generate a machine learning model for predicting client sensitivity to changes in rates;

FIG. 4 illustrates a combined block and logic diagram that depicts the generation of a client sensitivity metric for a potential rate adjustment for a client using a machine learning model;

FIG. 5 illustrates an example display indicating a client sensitivity metric for a client and a recommendation on whether to adjust a rate for the client; and

FIG. 6 is a flow diagram of an example method for predicting client sensitivity to changes in rates, which may be implemented in a server device.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Accordingly, as used herein, the term “rate” may refer to an interest rate, an ECR, or any other suitable rate for a commercial deposit product.

Generally speaking, the techniques for predicting client sensitivity to rate adjustments for commercial deposit products can be implemented in one or several client computing devices, one or several network servers or a system that includes a combination of devices. However, for clarity, the examples below focus primarily on an embodiment in which one or several banks provide training data to a client sensitivity assessment server. The training data may include attributes associated with clients which experienced a rate change for a commercial deposit product. The training data may also include indications of whether the rate changes were proactive or reactive, and changes in the clients' balances in the following months after the rate adjustment which may be used to generate client sensitivity metrics. Then the client sensitivity assessment server may generate the machine learning model based on the set of attributes for each rate change, the indication of whether each rate change was proactive or reactive, and client sensitivity metric for each rate change.

When the bank is deciding whether to change the rate for a particular client's commercial deposit product, the bank may provide attributes associated with the particular client, and an indication of whether the potential rate change is proactive or reactive to the client sensitivity assessment server. The client sensitivity assessment server may then apply the attributes and proactive or reactive indicator to the machine learning model to predict client sensitivity to the potential rate change. The machine learning model may provide a binary output such as sensitive or not sensitive. In other implementations, the machine learning model may provide a score (e.g., from 1 to 10) indicating the likelihood that the client will be sensitive to the rate change or the extent of the client's expected sensitivity to the rate change. For example, a score of 2 may indicate that the client will not be sensitive to the rate change, a score of 5 may indicate that the client will be somewhat sensitive to the rate change, and a score of 8 may indicate that the client will be very sensitive to the rate change.

In any event, the client sensitivity assessment server may then provide a client sensitivity metric to a client device (e.g., a client device for the bank) and/or a recommendation of whether to change the rate based on the client sensitivity metric. The client device may then display the client sensitivity metric and/or the recommendation to a user who may then determine whether to adjust the rate.

### Example Hardware and Software Components

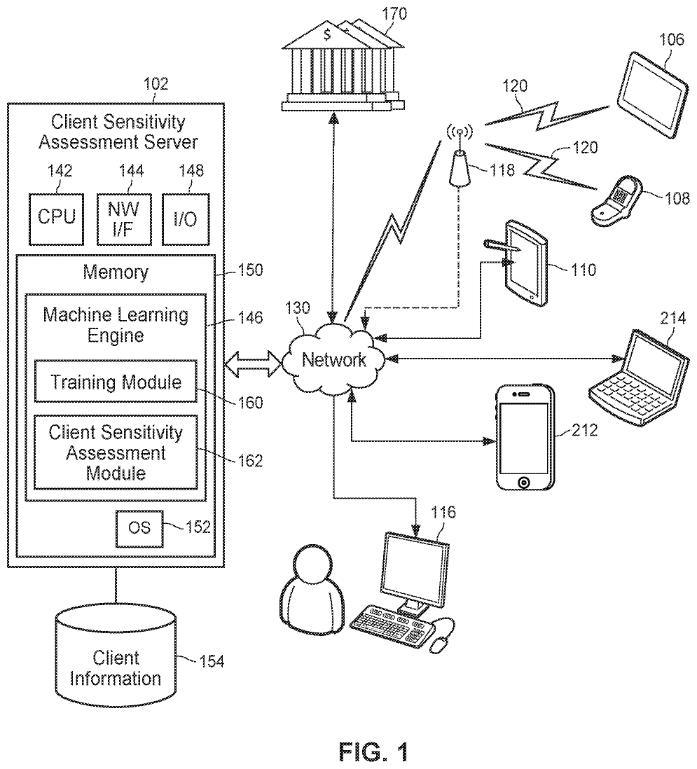

Referring to FIG. 1, an example client sensitivity assessment system 100 includes a client sensitivity assessment server 102, a plurality of client devices 106-116, and/or a plurality of banks 170 which may be communicatively connected through a network 130, as described below. In an embodiment, the client sensitivity assessment server 102 and the client devices 106-116 may communicate via wireless signals 120 over a digital network 130, which can be any suitable local or wide area network(s) including a Wi-Fi network, a Bluetooth network, a cellular network such as 3G, 4G, Long-Term Evolution (LTE), 5G, the Internet, etc. In some instances, the client devices 106-116 may communicate with the digital network 130 via an intervening wireless or wired device 118, which may be a wireless router, a wireless repeater, a base transceiver station of a mobile telephony provider, etc.

The client devices 106-116 may include, by way of example, a tablet computer 106, a network-enabled cell phone 108, a personal digital assistant (PDA) 110, a mobile device smart-phone 112 also referred to herein as a “mobile device,” a laptop computer 114, a desktop computer 116, a portable media player (not shown), a wearable computing device such as Google Glass™ (not shown), a smart watch, a phablet, any device configured for wired or wireless RF (Radio Frequency) communication, etc. The banks 170 may communicate with the client sensitivity assessment server 102 over the digital network 130 via client devices 106-116 or any other suitable devices. Moreover, any other suitable device that obtains banking information may also communicate with the client sensitivity assessment server 102. In some implementations, the client devices 106-116 may be client devices 106-116 owned or associated with the banks 170 for communicating banking information to the client sensitivity assessment server 102 and receiving client sensitivity data for the banks' clients.

Each of the client devices 106-116 may interact with the client sensitivity assessment server 102 to transmit attributes associated with clients having commercial deposit products that experienced rate adjustments. The client devices 106-116 may also transmit indications of whether the rate adjustments were proactive or reactive and indications of whether the clients were sensitive to the rate adjustments, such as changes in balances in the months following the rate adjustments.

Each client device 106-116 may also interact with the client sensitivity assessment server 102 to request a recommendation on whether to proceed with a potential rate change for a particular client and to receive the recommendation from the client sensitivity assessment server 102.

In an example implementation, the client sensitivity assessment server 102 may be a cloud based server, an application server, a web server, etc., and includes a memory 150, one or more processors (CPU) 142 such as a microprocessor coupled to the memory 150, a network interface unit 144, and an I/O module 148 which may be a keyboard or a touchscreen, for example.

The client sensitivity assessment server 102 may also be communicatively connected to a client information database 154. The client information database 154 may store the attributes and client sensitivity information associated with clients having commercial deposit products that experienced rate adjustments and/or machine learning models generated based on the attributes and client sensitivity information. The client information database 154 may also store attributes associated with clients having commercial deposit products where the corresponding banks are determining whether to make potential rate adjustments. These attributes may be applied to the machine learning model(s) to predict client sensitivity to the potential rate adjustments. Then after at least some of the potential rate adjustments are made and client sensitivity information can be determined based on the clients' reactions to the rate adjustments, the attributes and client sensitivity information may be stored as training data in the client information database 154 and used to update the machine learning model(s).

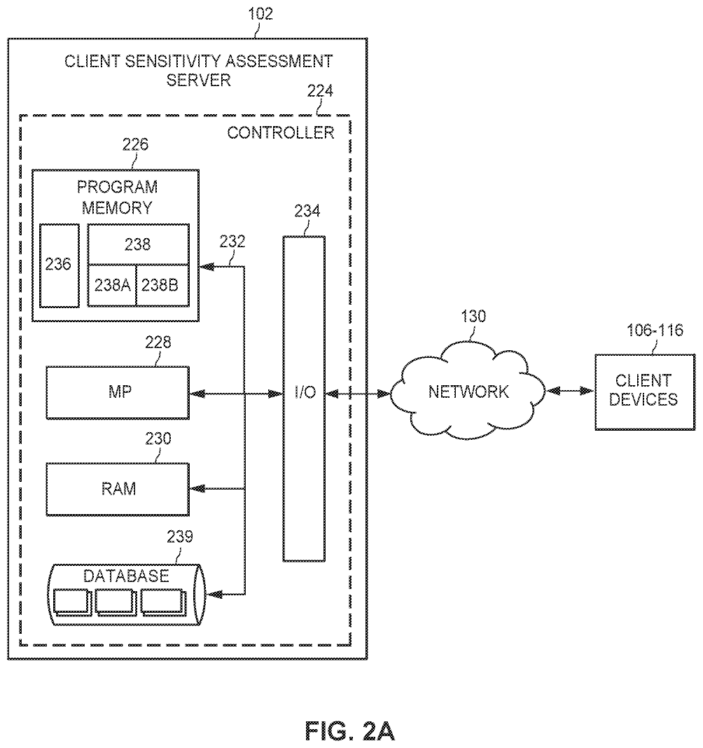

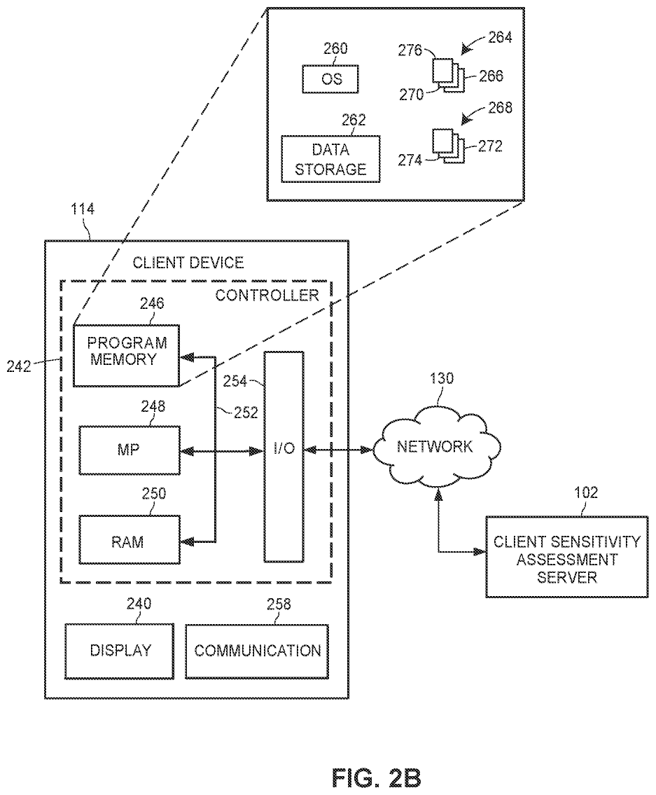

The memory 150 may be tangible, non-transitory memory and may include any types of suitable memory modules, including random access memory (RAM), read only memory (ROM), flash memory, other types of persistent memory, etc. The memory 150 may store, for example instructions executable of the processors 142 for an operating system (OS) 152 which may be any type of suitable operating system. The memory 150 may also store, for example instructions executable on the processors 142 for a machine learning engine 146 which may include a training module 160 and a client sensitivity assessment module 162. The client sensitivity assessment server 102 is described in more detail below with reference to FIG. 2A. In some embodiments, the machine learning engine 146 may be a part of one or more of the client devices 106-116, the client sensitivity assessment server 102, or a combination of the client sensitivity assessment server 102 and the client devices 106-116.

In any event, the machine learning engine 146 may receive training data from the client devices 106-116. For example, the machine learning engine 146 may obtain a set of training data by receiving attributes associated with clients which experienced a rate change for a commercial deposit product, such as a base rate, a change in the rate from the base rate to a new rate, an initial balance for the commercial deposit product, a change in balance after the change in the rate, a total balance between the client and the corresponding bank, a difference between an industry rate and the base rate, a difference between a federal funds rate and the base rate, a difference between a treasury bill rate and the base rate, a location of the client, a sales metric for the client, a relationship metric between the client and the corresponding bank, etc. The training data may also include indications of whether the rate changes were proactive or reactive, and client sensitivity information including changes in the clients' balances in the following months after the rate adjustments which may be used to generate client sensitivity metrics.

The training module 160 may segment the attributes and client sensitivity information into proactive and reactive segments. More specifically, the training module 160 may assign attributes and client sensitivity information where the corresponding banks initiated the rate changes with the clients to the proactive segment. The training module 160 may assign attributes and client sensitivity information where the clients initiated the rate changes with the corresponding banks to the reactive segment. The training module 160 may then analyze the attributes and client sensitivity information for each segment to generate a machine learning model for predicting client sensitivity to rate adjustments.

In some implementations, the training module 160 may generate a machine learning model for each segment. Also in some implementations, the training module 160 may generate a machine learning model for rate increases and another machine learning model for rate decreases. For example, a first machine learning model may be generated for proactive rate increases, a second machine learning model may be generated for reactive rate increases, a third machine learning model may be generated for proactive rate decreases, and a fourth machine learning model may be generated for reactive rate decreases.

In any event, the set of training data may be analyzed using various machine learning techniques, such as linear regression, polynomial regression, logistic regression, random forests, boosting such as adaptive boosting, gradient boosting, and extreme gradient boosting, nearest neighbors, Bayesian networks, neural networks, support vector machines, or any other suitable machine learning technique.

For example, when the machine learning technique is random forests, the training module 160 may collect several representative samples of the training data. Using each representative sample, the training module 160 may generate a decision tree for generating a client sensitivity metric. The training module 160 may then aggregate and/or combine each of the decision trees to generate the machine learning model, by for example averaging the client sensitivity metrics determined at each individual tree, calculating a weighted average, taking a majority vote, etc. In some embodiments, the training module 160 may also generate decision trees when the machine learning technique is boosting.

Each decision tree may include several nodes, branches, and leaves, where each node of the decision tree represents a test on a client attribute (e.g., is the change in the rate greater than 0.05%?). Each branch represents the outcome of the test (e.g., the rate change is greater than 0.05%). Moreover, each leaf represents a different client sensitivity metric (e.g., 1) based on the combined test outcomes for the branches which connect to the leaf.

For example, the training module 160 may generate a decision tree for a first machine learning model for proactive rate increases where a first node corresponds to whether the base rate is greater than 0.1%. If the base rate is greater than 0.1%, a first branch may connect to a first leaf node which may indicate that the client sensitivity metric is 0. If the base rate is less than 0.1%, a second branch may connect to a second node which corresponds to whether the change in the rate is greater than 0.05%.

If the change in the rate is greater than 0.05%, a third branch may connect to a second leaf node which may indicate that the client sensitivity metric is 1. However, if the change in the rate is not greater than 0.05%, a fourth branch may connect to a third node which corresponds to whether the difference between the federal funds rate and the base rate is greater than 0.02%. If the difference between the federal funds rate and the base rate is greater than 0.02%, a fifth branch may connect to the first leaf node indicating that the client sensitivity metric is 0. Otherwise, if the difference between the federal funds rate and the base rate is not greater than 0.02%, a sixth branch may connect to the second leaf node indicating that the client sensitivity metric is 1. While the decision tree includes two leaf nodes and six branches, this is merely an example for ease of illustration only. Each decision tree may include any number of nodes, branches, and leaves, having any suitable number and/or types of tests on client attributes.

In a testing phase, the training module 160 may apply test attributes for a test client to the machine learning model(s) to generate a client sensitivity metric. If the training module 160 generates an accurate client sensitivity metric or makes the correct determination of whether the client is sensitive to rate adjustments more frequently than a predetermined threshold amount, the statistical model may be provided to a client sensitivity assessment module 162. On the other hand, if the training module 160 does not generate an accurate client sensitivity metric or make the correct determination more frequently than the predetermined threshold amount, the training module 160 may continue to obtain training data for further training.

The client sensitivity assessment module 162 may obtain the machine learning model(s) as well as a set of attributes and a proactive/reactive indicator for a client where the bank is deciding whether to make a potential rate adjustment on the client's commercial deposit product. For example, a banker may input the attributes and proactive/reactive indicator on a client device 106-116 at one of the banks 170 which may be transmitted to the client sensitivity assessment server 102. The client sensitivity assessment module 162 may then apply the attributes and proactive/reactive indicator to the machine learning model(s). For example, when the training module 160 generates separate machine learning models for the proactive and reactive segments and/or for rate increases and rate decreases, the client sensitivity assessment module 162 may identify the machine learning model to use based on the proactive/reactive indicator and/or whether the potential rate adjustment is an increase or a decrease. The client sensitivity assessment module 162 may then apply the attributes associated with the client to the identified machine learning model. The machine learning model may then generate a client sensitivity metric may which may be a binary output such as sensitive (e.g., 1) or not sensitive (e.g., 0). In other implementations, the machine learning model may provide a score (e.g., from 1 to 10) indicating the likelihood that the client will be sensitive to the rate change or the extent of the client's expected sensitivity to the rate change. The client sensitivity metric may also be a probability (e.g., 0.6), a percentage (e.g., 80 percent), a category from a set of categories (e.g., “High,” “Medium,” or “Low”), and/or any other suitable metric.

The client sensitivity assessment module 162 then may cause the client sensitivity metric and/or a recommendation based on the client sensitivity metric to be displayed on a user interface of the client device 106-116 at the bank 170 for the banker to review.

The client sensitivity assessment server 102 may communicate with the client devices 106-116 and/or banks 170 via the network 130. The digital network 130 may be a proprietary network, a secure public Internet, a virtual private network and/or some other type of network, such as dedicated access lines, plain ordinary telephone lines, satellite links, combinations of these, etc. Where the digital network 130 comprises the Internet, data communication may take place over the digital network 130 via an Internet communication protocol.

Turning now to FIG. 2A, the client sensitivity assessment server 102 may include a controller 224. The controller 224 may include a program memory 226, a microcontroller or a microprocessor (MP) 228, a random-access memory (RAM) 230, and/or an input/output (I/O) circuit 234, all of which may be interconnected via an address/data bus 232. In some embodiments, the controller 224 may also include, or otherwise be communicatively connected to, a database 239 or other data storage mechanism (e.g., one or more hard disk drives, optical storage drives, solid state storage devices, etc.). The database 239 may include data such as training data, web page templates and/or web pages, and other data necessary to interact with users through the network 130. It should be appreciated that although FIG. 2A depicts only one microprocessor 228, the controller 224 may include multiple microprocessors 228. Similarly, the memory of the controller 224 may include multiple RAMs 230 and/or multiple program memories 226. Although FIG. 2A depicts the I/O circuit 234 as a single block, the I/O circuit 234 may include a number of different types of I/O circuits. The controller 224 may implement the RAM(s) 230 and/or the program memories 226 as semiconductor memories, magnetically readable memories, and/or optically readable memories, for example.

As shown in FIG. 2A, the program memory 226 and/or the RAM 230 may store various applications for execution by the microprocessor 228. For example, a user-interface application 236 may provide a user interface to the client sensitivity assessment server 102, which user interface may, for example, allow a system administrator to configure, troubleshoot, or test various aspects of the server's operation. A server application 238 may operate to receive a set of attributes and/or a proactive/reactive indicator for a client, determine a client sensitivity metric for the client, and transmit the client sensitivity metric and/or a recommendation based on the client sensitivity metric to a bankers' client device 106-116. The server application 238 may be a single module 238 or a plurality of modules 238A, 238B such as the training module 160 and the client sensitivity assessment module 162.

While the server application 238 is depicted in FIG. 2A as including two modules, 238A and 238B, the server application 238 may include any number of modules accomplishing tasks related to implementation of the client sensitivity assessment server 102. Moreover, it will be appreciated that although only one client sensitivity assessment server 102 is depicted in FIG. 2A, multiple client sensitivity assessment servers 102 may be provided for the purpose of distributing server load, serving different web pages, etc. These multiple client sensitivity assessment servers 102 may include a web server, an entity-specific server (e.g. an Apple® server, etc.), a server that is disposed in a retail or proprietary network, etc.

Referring now to FIG. 2B, the laptop computer 114 (or any of the client devices 106-116) may include a display 240, a communication unit 258, a user-input device (not shown), and, like the client sensitivity assessment server 102, a controller 242. Similar to the controller 224, the controller 242 may include a program memory 246, a microcontroller or a microprocessor (MP) 248, a random-access memory (RAM) 250, and/or an input/output (I/O) circuit 254, all of which may be interconnected via an address/data bus 252. The program memory 246 may include an operating system 260, a data storage 262, a plurality of software applications 264, and/or a plurality of software routines 268. The operating system 260, for example, may include Microsoft Windows®, OS X®, Linux®, Unix®, etc. The data storage 262 may include data such as client attributes and client sensitivity information, application data for the plurality of applications 264, routine data for the plurality of routines 268, and/or other data necessary to interact with the client sensitivity assessment server 102 through the digital network 130. In some embodiments, the controller 242 may also include, or otherwise be communicatively connected to, other data storage mechanisms (e.g., one or more hard disk drives, optical storage drives, solid state storage devices, etc.) that reside within the laptop computer 114.

The communication unit 258 may communicate with the client sensitivity assessment server 102 via any suitable wireless communication protocol network, such as a wireless telephony network (e.g., GSM, CDMA, LTE, etc.), a Wi-Fi network (802.11 standards), a WiMAX network, a Bluetooth network, etc. The user-input device (not shown) may include a “soft” keyboard that is displayed on the display 240 of the laptop computer 114, an external hardware keyboard communicating via a wired or a wireless connection (e.g., a Bluetooth keyboard), an external mouse, a microphone for receiving voice input or any other suitable user-input device. As discussed with reference to the controller 224, it should be appreciated that although FIG. 2B depicts only one microprocessor 248, the controller 242 may include multiple microprocessors 248. Similarly, the memory of the controller 242 may include multiple RAMs 250 and/or multiple program memories 246. Although the FIG. 2B depicts the I/O circuit 254 as a single block, the I/O circuit 254 may include a number of different types of I/O circuits. The controller 242 may implement the RAM(s) 250 and/or the program memories 246 as semiconductor memories, magnetically readable memories, and/or optically readable memories, for example.

The one or more processors 248 may be adapted and configured to execute any one or more of the plurality of software applications 264 and/or any one or more of the plurality of software routines 268 residing in the program memory 246, in addition to other software applications. One of the plurality of applications 264 may be a client application 266 that may be implemented as a series of machine-readable instructions for performing the various tasks associated with receiving information at, displaying information on, and/or transmitting information from the laptop computer 114.

One of the plurality of applications 264 may be a native application and/or web browser 270, such as Apple's Safari®, Google Chrome™, Microsoft Internet Explorer®, and Mozilla Firefox® that may be implemented as a series of machine-readable instructions for receiving, interpreting, and/or displaying web page information from the client sensitivity assessment server 102 while also receiving inputs from a user such as a banker. Another application of the plurality of applications may include an embedded web browser 276 that may be implemented as a series of machine-readable instructions for receiving, interpreting, and/or displaying web page information from the client sensitivity assessment server 102.

One of the plurality of routines may include a client sensitivity display routine 272 which obtains a client sensitivity metric and/or a recommendation based on the client sensitivity metric and displays the client sensitivity metric and/or recommendation on the display 240. Another routine in the plurality of routines may include a data entry routine 274 which obtains attributes associated with a client where the bank is deciding whether to make a potential rate adjustment for the client's commercial deposit product, and transmits the attributes along with an indication of whether the potential rate adjustment is proactive or reactive to the client sensitivity assessment server 102.

Preferably, a user may launch the client application 266 from a client device, such as one of the client devices 106-116 to communicate with the client sensitivity assessment server 102 to implement the client sensitivity assessment system 100. Additionally, the user may also launch or instantiate any other suitable user interface application (e.g., the native application or web browser 270, or any other one of the plurality of software applications 264) to access the client sensitivity assessment server 102 to realize the client sensitivity assessment system 100.

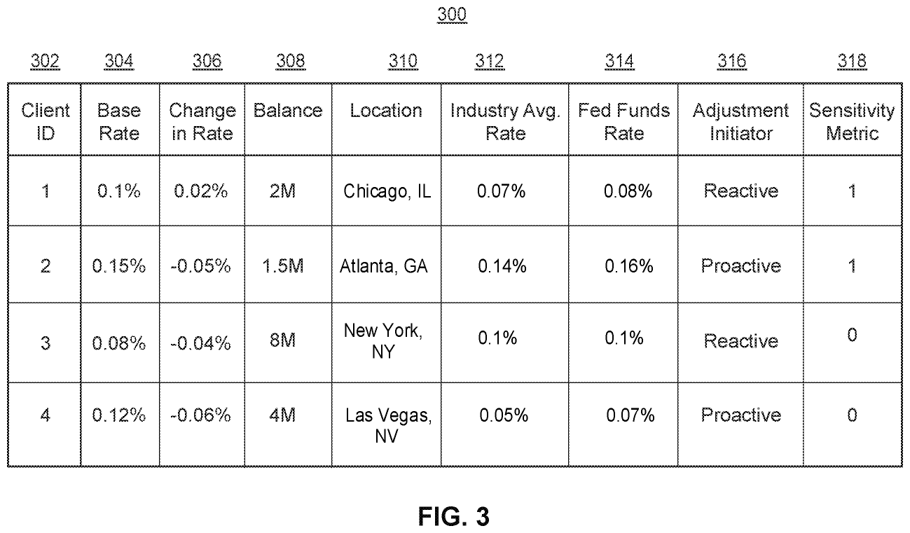

FIG. 3 illustrates example training data 300 that may be used to generate the machine learning model(s). In some embodiments, the training data 300 may be stored in the client information database 154. The training data 300 may include client attributes, an adjustment indicator 316 such as proactive or reactive, and a client sensitivity metric 318. In some implementations, the client sensitivity metric 318 is determined based on the change in the client's balance in the following threshold period after experiencing a rate adjustment. For example, the client sensitivity metric 318 may be 1 when the client's balance changes by more than a threshold amount (e.g., 35% and/or $50,000) over the threshold time period (e.g., 3 months) following a rate adjustment. The client sensitivity metric 318 may be 0 when the client's balance does not change by more than a threshold amount over the threshold time period following the rate adjustment.

In some implementations, the client sensitivity metric may be 1 when the three-month average deposit amount changes by more than 35% and more than $50,000 between the time of the rate adjustment and three months after the rate adjustment. The client sensitivity metric may be 0 when the three-month average deposit amount does not change by more than 35% or does not change by more than $50,000 between the time of the rate adjustment and three months after the rate adjustment.

In other implementations, the client sensitivity metric 318 may be the percentage change in the client's balance in the following threshold period after experiencing the rate adjustment, or the client sensitivity metric 318 may be in proportion to the percentage change. The client sensitivity metric 318 may be a numerical client sensitivity metric, for example a score from 1 to 10 or a percentage, may be a category selected from a set of categories such as sensitive, not sensitive, somewhat sensitive, very sensitive, etc., or may be any suitable metric indicating a likelihood that the client will significantly change their balance in response to a rate adjustment.

The client attributes may include a client identifier 302 which may be a unique identifier for the client, a base rate 304 before the rate adjustment, a change in the rate 306 after the rate adjustment, the client's balance 308 for the commercial deposit product, a location 310 of the client, an industry average rate 312, and a federal funds rate 314. The client's balance 308 for the commercial deposit product may be an initial balance for the commercial deposit product, a change in balance for the commercial deposit product after the rate adjustment, a total balance with the corresponding bank across one or more commercial deposit products, or any suitable combination of these.

The client attributes may also include a treasury bill rate (not shown), a difference between the federal funds rate and the base rate (not shown), a difference between the industry average rate and the base rate (not shown), a difference between the treasury bill rate and the base rate (not shown) and/or the type of industry for the client (e.g., autonomous vehicles, gaming, healthcare technology, ridesharing, nanotechnology, etc.).

Additionally, the client attributes may include a sales metric (not shown) for the client which may be indicative of the sales size for the client. The sales metric may be the annual revenue for the client, a score for example from 1 to 10 based on the annual revenue, a category selected from a set of categories based on the annual revenue, or any suitable metric of the sales size for the client.

The client attributes may further include a relationship metric (not shown) indicative of the value of the client's relationship with the bank. The relationship metric may be a score for example from 1 to 10, a category selected from a set of categories such as strong relationship, weak relationship, moderate relationship, or any suitable metric of the relationship between the client and the bank. The relationship metric may be determined based on the client's history with the bank, such as the amount of time that the client has been a client of the bank, historical balances that the client has maintained with the bank, loyalty rewards that the client has received with the bank, etc.

The training module 160 may analyze the training data 300 to generate the machine learning model(s) For example, the training module 160 may segment subsets of the training data 300 into proactive and reactive segments based on whether each rate adjustment was initiated by the bank or the client. For each segment, the training module 160 may classify portions of the segment of the training data 300 as corresponding to a particular client sensitivity metric (e.g., 1). Then the training module 160 may analyze each portion to generate the machine learning model. The machine learning model may be generated using various machine learning techniques such as linear regression, polynomial regression, logistic regression, random forests, boosting such as adaptive boosting, gradient boosting, and extreme gradient boosting, nearest neighbors, Bayesian networks, neural networks, support vector machines, or any other suitable machine learning technique.

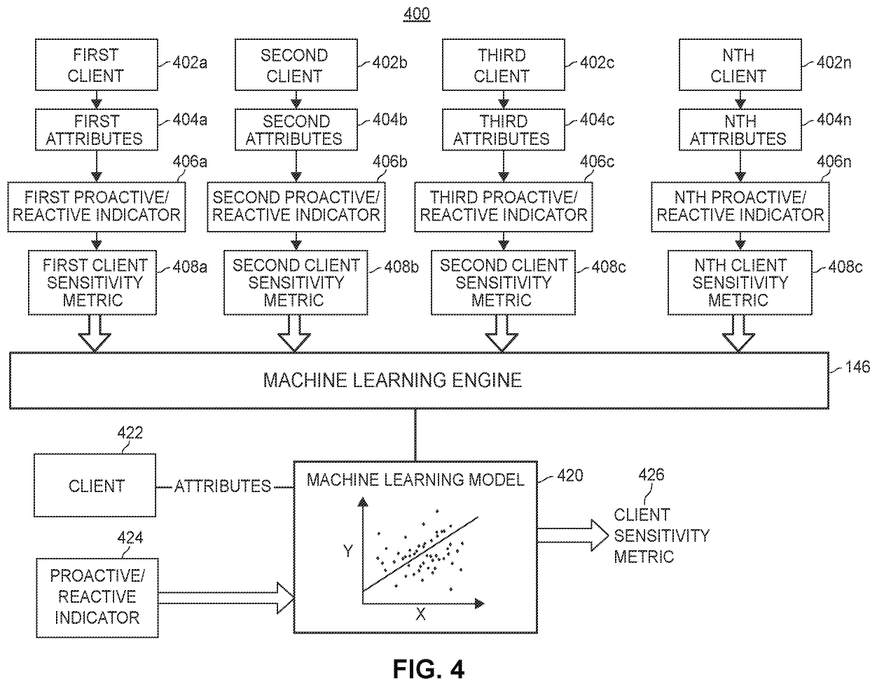

FIG. 4 schematically illustrates how the machine learning engine 146 of FIG. 1 determines the client sensitivity metric for a client where the bank is determining whether to make a potential rate adjustment in an example scenario. Some of the blocks in FIG. 4 represent hardware and/or software components (e.g., block 146), other blocks represent data structures or memory storing these data structures, registers, or state variables (e.g., blocks 402a-402n, 404a-404n, 406a-406n, 408a-408n), and other blocks represent output data (e.g., block 426). Input signals are represented by arrows labeled with corresponding signal names.

The machine learning engine 146 of FIG. 1 may be included within the client sensitivity assessment server 102 to generate the machine learning model 420. To generate the machine learning model 420, the machine learning engine 146 receives training data including an indication of a first client 402a that has experienced a rate adjustment on a commercial deposit product with a corresponding bank and a first set of attributes 404a associated with the first client 402a and/or the rate adjustment. Additionally, the training data includes a first proactive or reactive indicator 406a which indicates whether the rate adjustment was initiated by the bank or by the client, respectively, and a first client sensitivity metric 408a.

The training data also includes an indication of a second client 402b that has experienced a rate adjustment on a commercial deposit product with a corresponding bank, a second set of attributes 404b associated with the second client 402b and/or the rate adjustment, a second proactive or reactive indicator 406b, and a second client sensitivity metric 408b. Furthermore, the training data includes an indication of a third client 402c that has experienced a rate adjustment on a commercial deposit product with a corresponding bank, a third set of attributes 404c associated with the third client 402c and/or the rate adjustment, a third proactive or reactive indicator 406c, and a third client sensitivity metric 408c. Still further, the training data includes an indication of an nth client 402n that has experienced a rate adjustment on a commercial deposit product with a corresponding bank, an nth set of attributes 404n associated with the nth client 402n and/or the rate adjustment, an nth proactive or reactive indicator 406n, and an nth client sensitivity metric 408n. While the example training data includes indications of four clients 402a-402n, this is merely an example for ease of illustration only. The training data may include any number of clients that experienced rate changes for a commercial deposit product at any number of corresponding banks.

The machine learning engine 146 then analyzes the training data to generate a machine learning model 420 for generating a client sensitivity metric for a client where the corresponding bank is determining whether to make a potential rate adjustment to the client's commercial deposit product. While the machine learning model 420 is illustrated as a linear regression model, the machine learning model may be another type of regression model such as a logistic regression model, a decision tree, several decision trees, a neural network, a hyperplane, or any other suitable machine learning model.

In any event, in response to a request by a bank for a recommendation as to whether to make a potential rate adjustment to a client's 422 commercial deposit product, the system of FIG. 4 obtains a set of attributes associated with the client 422 and/or the potential rate adjustment, and an indication of whether the potential rate adjustment is initiated by the bank (proactive) or the client (reactive) 424. The set of attributes and proactive/reactive indicator 424 for the client 422 may be provided by the bank (e.g., via a client device 106-116), for example along with the request for a recommendation.

The machine learning engine 146 may then apply the set of attributes and the proactive/reactive indicator 424 to the machine learning model 420 to generate the client sensitivity metric 426 for the client 422. Then the machine learning engine 146 may provide the client sensitivity metric 426 to the bank and/or a recommendation as to whether the bank should make the potential rate adjustment. The bank may then present the client sensitivity metric 426 and/or the recommendation via a user interface of the client device 106-116.

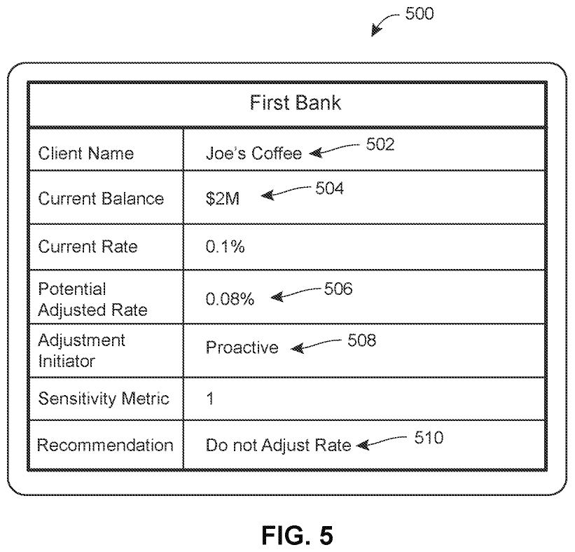

FIG. 5 illustrates an example bank display 500 which may be presented on the client device 106-116. The bank display 500 may include an indication of the client 502, client attributes such as the client's current balance 504, the base rate 506, and the potential adjusted rate 508. The bank display 500 may also include an indication of the initiator of the potential rate adjustment 510, a client sensitivity metric 512, and/or a recommendation as to whether or not to adjust the rate 514.

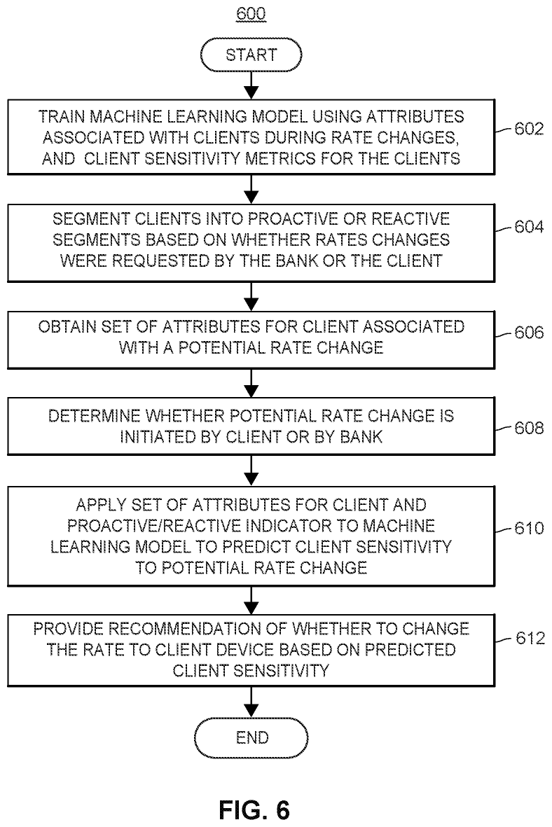

FIG. 6 illustrates an example method 600 for predicting client sensitivity to changes in rates, which can be implemented at a network server (such as the client sensitivity assessment server 102), for example. The method can be implemented in a set of instructions stored on a computer-readable memory and executable at one or more processors of the client sensitivity assessment server 102. For example, the method can be implemented by the machine learning engine 146.

At block 602, the client sensitivity assessment server 102 trains a machine learning model for predicting client sensitivity to rate adjustments for client's commercial deposit products using (i) attributes associated with clients that experienced a rate adjustment on a commercial deposit product, (ii) indications of whether the rate adjustments were proactive or reactive rate adjustments, and (iii) client sensitivity metrics for the clients as training data. The attributes associated with the clients may include a base rate, a change in the rate from the base rate to a new rate, an initial balance for the commercial deposit product, a change in balance after the change in the rate, a total balance between the client and the corresponding bank, a difference between an industry rate and the base rate, a difference between a federal funds rate and the base rate, a difference between a treasury bill rate and the base rate, a location of the client, a sales metric for the client, a relationship metric between the client and the corresponding bank, etc. The training data may also include indications of whether the rate changes were proactive or reactive, and client sensitivity information including changes in the clients' balances in the following months after the rate adjustment which may be used to generate client sensitivity metrics.

Then at block 604, the client sensitivity assessment server 102 segments the attributes and corresponding client sensitivity metrics into proactive and reactive segments. More specifically, the client sensitivity assessment server 102 may assign attributes and client sensitivity metrics where the corresponding banks initiated the rate changes with the clients to the proactive segment. The client sensitivity assessment server 102 may assign attributes and client sensitivity metrics where the clients initiated the rate changes with the corresponding banks to the reactive segment.

In some implementations, the client sensitivity assessment server 102 may generate a machine learning model for each segment. Also in some implementations, the client sensitivity assessment server 102 may generate a machine learning model for rate increases and another machine learning model for rate decreases. For example, a first machine learning model may be generated for proactive rate increases, a second machine learning model may be generated for reactive rate increases, a third machine learning model may be generated for proactive rate decreases, and a fourth machine learning model may be generated for reactive rate decreases.

Also in some implementations, each of the attributes for a particular segment may be classified according to their corresponding client sensitivity metric (e.g., a first set of attributes having a first client sensitivity metric may be classified into a first group, a second set of attributes having a second client sensitivity metric may be classified into a second group, etc.). The client sensitivity assessment server 102 may then analyze the attributes in each group to generate the machine learning model for a particular segment using machine learning techniques, such as linear regression, polynomial regression, logistic regression, random forests, boosting such as adaptive boosting, gradient boosting, and extreme gradient boosting, nearest neighbors, Bayesian networks, neural networks, support vector machines, or any other suitable machine learning technique.

At block 606, a request is received for a recommendation as to whether to make a potential rate adjustment to a client's commercial deposit product along with a set of attributes associated with the client. The client sensitivity assessment server 102 may also receive an indication of whether the potential rate adjustment is proactive or reactive (block 608).

The client sensitivity assessment server 102 may apply the attributes associated with the client to the machine learning model(s) (block 610) to generate a client sensitivity metric for the client for the potential rate adjustment. Additionally, the client sensitivity assessment server 102 may identify the segment for the client based on the received proactive/reactive indicator and may apply the attributes associated with the client to the machine learning model for the identified segment.

Then at block 612, the client sensitivity assessment server 102 may provide the client sensitivity metric to a client device 106-116 for display to a banker. The client sensitivity assessment server 102 may also provide a recommendation as to whether the bank should make the potential rate adjustment for the client's commercial deposit product. For example, when the rate adjustment is an upward rate adjustment and the client sensitivity metric is 1 or another suitable metric indicating that the client is sensitive to rate adjustments, the client sensitivity assessment server 102 may recommend proceeding with the rate adjustment which may cause the client to significantly increase their balance. When the rate adjustment is a downward rate adjustment and the client sensitivity metric is 1 or another suitable metric indicating that the client is sensitive to rate adjustments, the client sensitivity assessment server 102 may not recommend proceeding with the rate adjustment to prevent the client from significantly decreasing their balance. When the rate adjustment is an upward rate adjustment and the client sensitivity metric is 0 or another suitable metric indicating that the client is not sensitive to rate adjustments, the client sensitivity assessment server 102 may not recommend proceeding with the rate adjustment to avoid paying higher rates when it is not likely to lead to additional deposits from the client. When the rate adjustment is a downward rate adjustment and the client sensitivity metric is 0 or another suitable metric indicating that the client is not sensitive to rate adjustments, the client sensitivity assessment server 102 may recommend proceeding with the rate adjustment to pay lower rates when it is unlikely that the client will withdraw from their balance.

The client device 106-116 may then display the client sensitivity metric and/or the recommendation on a bank display, such as the bank display 500 as shown in FIG. 5.

### ADDITIONAL CONSIDERATIONS

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for predicting client sensitivity to rate adjustments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for predicting client sensitivity to changes in rates, the method comprising:
training, by one or more processors, a machine learning model using, for each of a plurality of first commercial deposit products provided by one or more first banks for one or more first clients experiencing a change in a first rate, (i) first attributes associated with a corresponding first client during the change in the first rate for the first commercial deposit product, (ii) an indication of whether the change in the first rate was requested by the corresponding first client or by a corresponding first bank, and (iii) an indication of whether the corresponding first client is sensitive to the change in the first rate;
obtaining, by the one or more processors, a second set of attributes associated with a second client having a second commercial deposit product provided by a second bank;
determining, by the one or more processors, whether a potential change in a second rate for the second commercial deposit product for the second client is initiated by the second client or the second bank;
applying, by the one or more processors, the second set of attributes associated with the second client and an indication of an initiator of the potential second rate change to the machine learning model to predict client sensitivity to the potential second rate change; and
providing, by the one or more processors, a recommendation of whether to change the second rate based on the predicted client sensitivity.

2. The method of claim 1, wherein training the machine learning model further comprises:
segmenting, by the one or more processors, the changes in the first rates for the plurality of first commercial deposit products into proactive or reactive segments based on whether the change in the first rate was requested by the corresponding first bank or by the corresponding first client.

3. The method of claim 2, wherein training the machine learning model further comprises:
training, by the one or more processors, a first machine learning model using a first subset of the first attributes associated with a proactive segment of the plurality of first commercial deposit products; and
training, by the one or more processors, a second machine learning model using a second subset of the first attributes associated with a reactive segment of the plurality of first commercial deposit products.

4. The method of claim 3, wherein applying the second set of attributes to the machine learning model includes:
in response to determining that the potential change in the second rate for the second commercial deposit product for the second client is initiated by the second bank, applying, by the one or more processors, the second set of attributes associated with the second client to the first machine learning model to predict client sensitivity to the potential second rate change.

5. The method of claim 3, wherein applying the second set of attributes to the machine learning model includes:
in response to determining that the potential change in the second rate for the second commercial deposit product for the second client is initiated by the second client, applying, by the one or more processors, the second set of attributes associated with the second client to the second machine learning model to predict client sensitivity to the potential second rate change.

6. The method of claim 1, wherein training the machine learning model includes training the machine learning model using one or more machine learning techniques including at least one of: linear regression, polynomial regression, logistic regression, decision trees, random forests, boosting, nearest neighbors, Bayesian networks, neural networks, or support vector machines.

7. The method of claim 1, wherein:
the indication of whether the corresponding first client is sensitive to the change in the first rate includes an indication that the corresponding first client is sensitive to the change in the first rate when a balance for the first commercial deposit product changes by more than a threshold amount over a threshold time period in response to the change in the first rate, and
the indication of whether the corresponding first client is sensitive to the change in the first rate includes an indication that the corresponding first client is not sensitive to the change in the first rate when the balance for the first commercial deposit product does not change by more than the threshold amount over the threshold time period in response to the change in the first rate.

8. The method of claim 1, wherein the first attributes associated with the corresponding first client include at least one of: a base first rate, the change in the first rate from the base first rate to a new first rate, an initial balance for the first commercial deposit product, a change in balance after the change in the first rate, a total balance between the corresponding first client and the corresponding first bank, a difference between an industry rate and the base first rate, a difference between a federal funds rate and the base first rate, a difference between a treasury bill rate and the base first rate, a location of the corresponding first client, a sales metric for the corresponding first client, or a relationship metric between the corresponding first client and the corresponding first bank.

9. The method of claim 1, wherein the first and second rates are interest rates or earned credit rates.

10. A computing device for predicting client sensitivity to changes in rates, the computing device comprising:
one or more processors; and
a non-transitory computer-readable memory coupled to the one or more processors and storing instructions thereon that, when executed by the one or more processors, cause the computing device to:
train a machine learning model using, for each of a plurality of first commercial deposit products provided by one or more first banks for one or more first clients experiencing a change in a first rate, (i) first attributes associated with a corresponding first client during the change in the first rate for the first commercial deposit product, (ii) an indication of whether the change in the first rate was requested by the corresponding first client or by a corresponding first bank, and (iii) an indication of whether the corresponding first client is sensitive to the change in the first rate;
obtain a second set of attributes associated with a second client having a second commercial deposit product provided by a second bank;
determine whether a potential change in a second rate for the second commercial deposit product for the second client is initiated by the second client or the second bank;
apply the second set of attributes associated with the second client and an indication of an initiator of the potential second rate change to the machine learning model to predict client sensitivity to the potential second rate change; and
provide a recommendation of whether to change the second rate based on the predicted client sensitivity.

11. The computing device of claim 10, wherein to train the machine learning model, the instructions cause the computing device to:
segment the changes in the first rates for the plurality of first commercial deposit products into proactive or reactive segments based on whether the change in the first rate was requested by the corresponding first bank or by the corresponding first client.

12. The computing device of claim 11, wherein to train the machine learning model, the instructions cause the computing device to:
train a first machine learning model using a first subset of the first attributes associated with a proactive segment of the plurality of first commercial deposit products; and
train a second machine learning model using a second subset of the first attributes associated with a reactive segment of the plurality of first commercial deposit products.

13. The computing device of claim 12, wherein to apply the second set of attributes to the machine learning model, the instructions cause the computing device to:
in response to determining that the potential change in the second rate for the second commercial deposit product for the second client is initiated by the second bank, apply the second set of attributes associated with the second client to the first machine learning model to predict client sensitivity to the potential second rate change.

14. The computing device of claim 12, wherein to apply the second set of attributes to the machine learning model, the instructions cause the computing device to:
in response to determining that the potential change in the second rate for the second commercial deposit product for the second client is initiated by the second client, apply the second set of attributes associated with the second client to the second machine learning model to predict client sensitivity to the potential second rate change.

15. The computing device of claim 10, wherein the machine learning model is trained using one or more machine learning techniques including at least one of: linear regression, polynomial regression, logistic regression, decision trees, random forests, boosting, nearest neighbors, Bayesian networks, neural networks, or support vector machines.

16. The computing device of claim 10, wherein:
the indication of whether the corresponding first client is sensitive to the change in the first rate includes an indication that the corresponding first client is sensitive to the change in the first rate when a balance for the first commercial deposit product changes by more than a threshold amount over a threshold time period in response to the change in the first rate, and
the indication of whether the corresponding first client is sensitive to the change in the first rate includes an indication that the corresponding first client is not sensitive to the change in the first rate when the balance for the first commercial deposit product does not change by more than the threshold amount over the threshold time period in response to the change in the first rate.

17. The computing device of claim 10, wherein the first attributes associated with the corresponding first client include at least one of: a base first rate, the change in the first rate from the base first rate to a new first rate, an initial balance for the first commercial deposit product, a change in balance after the change in the first rate, a total balance between the corresponding first client and the corresponding first bank, a difference between an industry rate and the base first rate, a difference between a federal funds rate and the base first rate, a difference between a treasury bill rate and the base first rate, a location of the corresponding first client, a sales metric for the corresponding first client, or a relationship metric between the corresponding first client and the corresponding first bank.

18. The computing device of claim 10, wherein the first and second rates are interest rates or earned credit rates.

19. A non-transitory computer-readable memory coupled to the one or more processors and storing instructions thereon that, when executed by the one or more processors, cause the one or more processors to:
train a machine learning model using, for each of a plurality of first commercial deposit products provided by one or more first banks for one or more first clients experiencing a change in a first rate, (i) first attributes associated with a corresponding first client during the change in the first rate for the first commercial deposit product, (ii) an indication of whether the change in the first rate was requested by the corresponding first client or by a corresponding first bank, and (iii) an indication of whether the corresponding first client is sensitive to the change in the first rate;
obtain a second set of attributes associated with a second client having a second commercial deposit product provided by a second bank;
determine whether a potential change in a second rate for the second commercial deposit product for the second client is initiated by the second client or the second bank;
apply the second set of attributes associated with the second client and an indication of an initiator of the potential second rate change to the machine learning model to predict client sensitivity to the potential second rate change; and
provide a recommendation of whether to change the second rate based on the predicted client sensitivity.

20. The non-transitory computer-readable memory of claim 19, wherein to train the machine learning model, the instructions cause the one or more processors to:
segment the changes in the first rates for the plurality of first commercial deposit products into proactive or reactive segments based on whether the change in the first rate was requested by the corresponding first bank or by the corresponding first client.
